(19) United States
(12) Patent Application Publication
(10) Pub. No.: US 2010/0257373 A1
(43) Pub. Date: Oct. 7, 2010

(54) CRYPTOGRAPHIC PROCESSOR AND IC CARD

(75) Inventor: Masahiko Motoyama, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/715,558

(22) Filed: Mar. 2, 2010

(30) Foreign Application Priority Data
Apr. 7, 2009 (JP) 2009-093117

(51) Int. Cl. G06F 12/14

(52) U.S. Cl. 713/189

(57) ABSTRACT

A cryptographic processor has a first cryptographic processing circuit configured to perform first cryptographic processing on input first data, and a second cryptographic processing circuit configured to perform second cryptographic processing different from the first cryptographic processing on input second data by using a processing result from the first cryptographic processing circuit as mask data.

### CROSS-REFERENCE TO RELATED APPLICATIONS

This application is based upon and claims the benefit of priority from the prior Japanese Patent Application No. 2009-93117 filed in Japan on Apr. 7, 2009; the entire contents of which are incorporated herein by reference.

### BACKGROUND OF THE INVENTION

1. Field of the Invention

The present invention relates to a cryptographic processor and an IC card and, more particularly, to a cryptographic processor and an IC card in which cryptographic processing is performed by using mask data.

2. Description of the Related Art

A method of power analysis for taking out secure information used in a cryptographic processor making use of electric power consumed in the cryptographic processor is known. As a countermeasure against such an analytic method, a technique called a data masking method is proposed in Japanese Patent Application Laid-Open Publication No. 2000-66585 for example. According to the data masking method, a random number generation circuit generates random numbers as mask data and a cryptographic processing circuit executes cryptographic processing while performing data masking using mask data supplied from the random number generation circuit.

Ordinarily, in the data masking method, input plaintext is converted into irrelevant data by performing an operation such as exclusive OR of the input plaintext and random numbers provided as mask data. The resistance to a power analysis attack is improved by performing cryptographic processing in this way.

In general, random numbers used as mask data are generated by a random number generation circuit. However, the circuit scale of the random number generation circuit is increased because an output from the random number generation circuit must be produced each time an operation clock signal is generated. As a result, a problem arises that the area occupied by the random number generation circuit on a semiconductor chip on which a cryptographic processor is formed is also increased.

In particular, in a case where a plurality of types of cryptographic processing circuits such as ones in conformity with DES and AES are incorporated in an IC card or the like, it is necessary to generate random numbers respectively corresponding to the cryptographic processing circuits, so that the scale of the random number generation circuit is further increased.

### BRIEF SUMMARY OF THE INVENTION

According to one aspect of the present invention, there is provided a cryptographic processor having a first cryptographic processing circuit configured to perform first cryptographic processing on input first data, and a second cryptographic processing circuit configured to perform second cryptographic processing different from the first cryptographic processing on input second data by using a processing result from the first cryptographic processing circuit as mask data.

### BRIEF DESCRIPTION OF THE DRAWINGS

FIG. 1 is a configuration diagram showing the configuration of a cryptographic processor 1 according to a first embodiment of the present invention;

FIG. 2 is a block diagram showing the configuration of a cryptographic circuit module 15 according to the first embodiment of the present invention;

FIG. 3 is a block diagram showing the configuration of the cryptographic circuit module 15 in a case where a round function in accordance with AES and a round function in accordance with DES are used as two round function operation circuits in the first embodiment;

FIG. 4 is a block diagram showing the configuration of a mask generation circuit 30 shown in FIG. 3;

FIG. 5 is a block diagram showing the configuration of a cryptographic circuit module 15A according to a second embodiment of the present invention; and

FIG. 6 is a block diagram showing the configuration of a cryptographic circuit module 15B according to a third embodiment of the present invention.

### DETAILED DESCRIPTION OF THE INVENTION

Embodiments of the present invention will be described below with reference to the accompanying drawings.

### First Embodiment

### Configuration

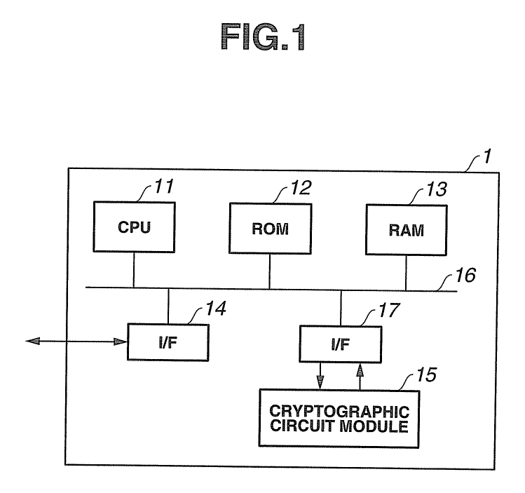

The configuration of a cryptographic processor incorporating a cryptographic processing circuit according to a first embodiment of the present invention will be described with reference to FIG. 1. FIG. 1 is a configuration diagram showing the configuration of a cryptographic processor 1 according to the first embodiment.

The cryptographic processor 1 is configured by including a central processing unit (CPU) 11, a ROM 12 in which data including a program is stored, a RAM 13 provided as a work storage area for the CPU 11, a transmitting-receiving interface circuit (hereinafter abbreviated to “transmitting/receiving I/F”) 14 for transmitting and receiving data to and from the outside, a cryptographic circuit module 15, which is a cryptographic processing circuit, and a cryptographic circuit I/F 17 provided between the cryptographic circuit module 15 and a bus 16. The CPU 11, the ROM 12, the RAM 13, the transmitting/receiving I/F 14 and the cryptographic circuit I/F 17 are connected to each other through the bus 16.

The cryptographic processor 1 is, for example, an integrated circuit (IC) card. When the cryptographic processor 1 receives data from an external device (not shown) such as a card reader device, it performs predetermined cryptographic processing on the data and outputs data as a result of the cryptographic processing. Transmitting and receiving of data to and from the external device are performed through the transmitting/receiving I/F 14 by wireless communication, for example, through a circuit (not shown) for wireless communication.

Data transmitted and received between the CPU 11 and the cryptographic circuit module 15 is also encrypted. Therefore, circuits (not shown) configured to perform exclusive OR operation for example are respectively provided between the CPU 11 and the bus 16 and between the bus 16 and the cryptographic circuit I/F 17.

The cryptographic circuit module 15 includes two types of cryptographic processing circuits, which execute cryptographic processes different from each other, i.e., encryption processes, decryption processes, or encryption and decryption processes.

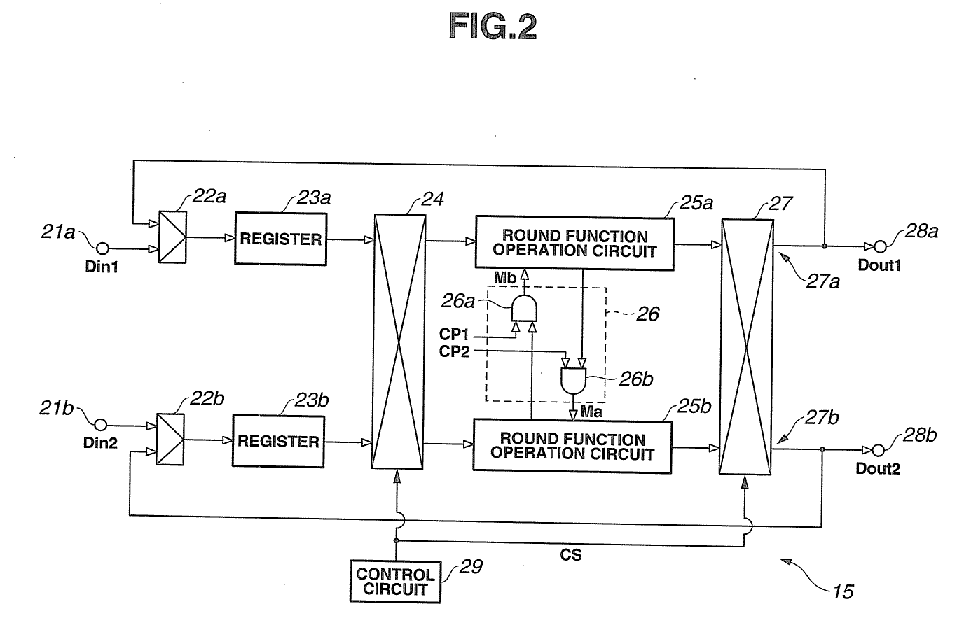

FIG. 2 is a block diagram showing the configuration of the cryptographic circuit module 15.

As shown in FIG. 2, the cryptographic circuit module 15 is configured so as to have input terminals 21a and 21b, selecting circuits 22a and 22b, registers 23a and 23b, a switchover circuit (hereinafter referred to as “switch circuit”) 24, round function operation circuits 25a and 25b, configured to compute predetermined round functions different from each other, a mask generation circuit 26, a switch circuit 27, output terminals 28a and 28b, and a control circuit 29.

The two input terminals 21a and 21b are input terminals through which groups of input data Din1 and Din2 from the cryptographic circuit I/F 17 are respectively input. Each of the two selecting circuits 22a and 22b is a circuit for selecting a round function operation result output and input data. The registers 23a and 23b are circuits for holding input data or results of round function operations.

The switch circuit 24 is a switchover circuit configured to make a switchover by a control signal from the control circuit 29 between supplying outputs from the registers 23a and 23b to the round function operation circuits 25a and 25b, respectively, and supplying the outputs to the round function operation circuits 25b and 25a, respectively.

The round function operation circuits 25a and 25b are circuits each of which is configured to execute predetermined encryption operation processing or predetermined decryption operation processing. Accordingly, cryptographic processing means encryption processing or decryption processing. The round function operation circuit 25a is a cryptographic processing circuit configured to perform on input data predetermined cryptographic processing different from processing performed by the round function operation circuit 25b by using as mask data Mb a result of the processing performed by the round function operation circuit 25b. The round function operation circuit 25b is a cryptographic processing circuit configured to perform on input data predetermined cryptographic processing different from the processing performed by the round function operation circuit 25a by using as mask data Ma a result of the processing performed by the round function operation circuit 25a.

The mask generation circuit 26 is a circuit configured to generate mask data from intermediate result data in round function operation output from the round function operation circuits, and to supply the mask data to the round function operation circuit that uses the mask data.

The switch circuit 27 is a switchover circuit configured to make a switchover by a control signal CS from the control circuit 29 between supplying result outputs from the two round function operation circuits 25a and 25b to the registers 23a and 23b, respectively, and supplying the outputs to the registers 23b and 23a, respectively.

The output terminals 28a and 28b are terminals through which output data Dout1 and Dout2 are output from the two round function operation circuits 25a and 25b via the switch circuit 27.

The control circuit 29 is a circuit configured to generate the control signal CS for changing output ends of the switch circuits 24 and 27 through which input data is output, and to output the control signal CS to the switch circuits 24 and 27.

The mask generation circuit 26 includes two AND circuits 26a and 26b. A cryptographic operation designation signal CP1 for designating the circuit to perform a cryptographic operation is input to the AND circuit 26a through one of two input terminals of the same. Intermediate result data from the round function operation circuit 25b is input to the AND circuit 26a through the other of the two input terminals of the same. When the cryptographic operation designation signal CP1 is high, intermediate result data from the round function operation circuit 25b is output to the round function operation circuit 25a.

Similarly, a cryptographic operation designation signal CP2 for designating the circuit to perform a cryptographic operation is input to the AND circuit 26b through one of two input terminals of the same. Intermediate result data from the round function operation circuit 25a is input to the AND circuit 26b through the other of the two input terminals of the same. When the cryptographic operation designation signal CP2 is high, intermediate result data from the round function operation circuit 25a is output to the round function operation circuit 25b.

In the present embodiment, the cryptographic operation designation signals CP1 and CP2 are supplied from the CPU 11 directly or via the control circuit 29 from the CPU 11, and only one of the two signals becomes high.

### Operation

The operation of the cryptographic circuit module 15 shown in FIG. 2 will now be described.

Groups of input data Din1 and Din2 to be supplied to the round function operation circuits 25a and 25b are respectively supplied to the input terminals 21a and 21b and are respectively transferred to the selecting circuits 22a and 22b. The selecting circuits 22a and 22b respectively select input data Din1 and Din2 and output the data to the registers 23a and 23b.

A case will be described as an example where input data Din1 is cryptographic processing object data supplied to the input terminal 21a and given to the register 23a through the selecting circuit 22a, while input data Din2 is data irrelevant to input data Din1 and supplied to the input terminal 21b.

The selecting circuit 22a first selects the input terminal 21a. The register 23a holds input data Din1 transferred from the selecting circuit 22a. The data held in the register 23a is transferred to the round function operation circuit 25a or 25b according to the operation of the switch circuit 24. The switch circuit 24 transfers the data held in the register 23a to one of the round function operation circuits 25a and 25b on the basis of the control signal CS from the control circuit 29, and transfers the data held in the register 23b to the other of the round function operation circuits 25a and 25b not used for cryptographic processing on input data Din1. Description will be made below of a case where the round function operation circuit 25b performs cryptographic processing on input data Din1.

That is, input data Din1 to be subjected to cryptographic processing is held in the register 23a, and the switch circuit 24 performs input data switching so that the data held in the register 23a is output to the round function operation circuit 25b. At this time, the data held in the register 23b is transferred to the round function operation circuit 25a.

The round function operation circuit 25b capable of a cryptographic algorithm operation on input data Din1 performs a predetermined round function operation using the input data. On the other hand, the round function operation circuit 25a performs a predetermined round function operation using input data Din2 held in the register 23b and irrelevant to input data Din1, and outputs data on an intermediate result of the operation to the mask generation circuit 26.

At this time, the cryptographic operation designation signal CP2 is high and the intermediate result data from the round function operation circuit 25a is supplied from the AND circuit 26b to the round function operation circuit 25b as mask data. Accordingly, the round function operation circuit 25b executes predetermined cryptographic processing by using the data supplied from the AND circuit 26b as mask data for data masking.

The intermediate result data is produced from data Din2 irrelevant to input data Din1 as a result of an operation based on a cryptographic algorithm different from the cryptographic algorithm to be computed for cryptographic processing on input data Din1, and is thus irrelevant to input data Din1.

That is, the mask generation circuit 26 generates mask data by using intermediate result data from the round function operation circuit 25a and supplies the mask data to the round function operation circuit 25b configured to compute the cryptographic algorithm to be executed. The round function operation circuit 25b processes the data input from the switch circuit 24 by using the mask data output from the mask generation circuit 26. A result of processing is supplied to the switch circuit 27.

Also, the round function operation circuit 25a performs a predetermined round function operation by using data irrelevant to input data Din1 and also supplies data obtained as a result of this operation to the switch circuit 27. To the switch circuit 27, output data from the round function operation circuit 25b using the cryptographic algorithm to be executed and the result data from the round function operation circuit 25a using the cryptographic algorithm different from the cryptographic algorithm to be executed are input. The switch circuit 27 outputs the two groups of input operation result data through the two output terminals according to the control signal CS.

Data switching in the switch circuits 24 and 27 may be performed in a random selection manner or in such a manner that one of the two groups of data is selected at all times.

For example, in the case where the switch circuit 27 operates so that a result from the round function operation circuit 25b is output from the output terminal 27b, data to be subjected to the cryptographic operation is held in the register 23b, while data irrelevant to the cryptographic operation is held in the other register 23a.

When the next round function operation is performed, the switch circuit 24 is controlled by the control signal CS from the control circuit 29 so as to transfer data from the register 23b to the round function operation circuit 25b and to transfer data from the register 23a to the round function operation circuit 25a.

Conversely, in the case where the switch circuit 27 operates so that a result from the round function operation circuit 25b is output from the output terminal 27a, data to be subjected to the cryptographic operation is held in the register 23a, while data irrelevant to the cryptographic operation is held in the register 23b. In this case, when the next round function operation is performed, the switch circuit 24 is controlled by the control signal CS from the control circuit 29 so as to transfer data from the register 23a to the round function operation circuit 25b and to transfer data from the register 23b to the round function operation circuit 25a.

Subsequently, the same processing is repeated and the cryptographic operation is performed by repeating the round function operation the necessary number of times. In the round function operation circuit 25b, intermediate result data from the round function operation circuit 25a is used as mask data each time the round function operation is performed. A final operation result is output from the output terminal 28a or 28b. With respect to a certain kind of cryptographic algorithm, necessary processing after the round function operation is performed to produce and output cryptographic operation results.

A case where the round function operation circuit 25b performs cryptographic processing has been described above. In a case where the round function operation circuit 25a executes cryptographic processing, input data Din2 is supplied to the input terminal 21b as input data to be subjected to the cryptographic operation. The operation of the module after this input is the same as described above.

In cryptographic processing in the above-described cryptographic processor 1, intermediate result data from the cryptographic operation circuit not used for cryptographic processing on input data to be subjected to cryptographic processing is used as mask data, as described above. Thus, the need for a random number generation circuit for generating mask data for data masking is eliminated to enable prevention of an increase in circuit area in cryptographic processor.

In the cryptographic processor according to the present embodiment, as described above, the cryptographic operation based on a data masking method is performed by using, as mask data for the round function operation circuit, instead of random numbers generated outside the cryptographic processing circuit, intermediate result data obtained by processing data irrelevant to the input data in the round function operation circuit that does not perform cryptographic processing on the cryptographic processing object data. That is, the cryptographic processor according to the present embodiment is capable of cryptographic processing based on a data masking method without inputting random numbers from the outside of the cryptographic processing circuit.

The above-described mask generation circuit 26 directly selects the outputs from the round function operation circuits 25a and 25b and issues the outputs as mask data. However, the arrangement may alternatively be such that the mask generation circuit 26 generates mask data by performing predetermined operational processing on the outputs from the round function operation circuits 25a and 25b.

A concrete example of a case where cryptographic algorithms in accordance with AES and DES are used as the above-described two round functions will be described next.

(Example of configuration in a case where cryptographic algorithms in accordance with AES and DES are used)

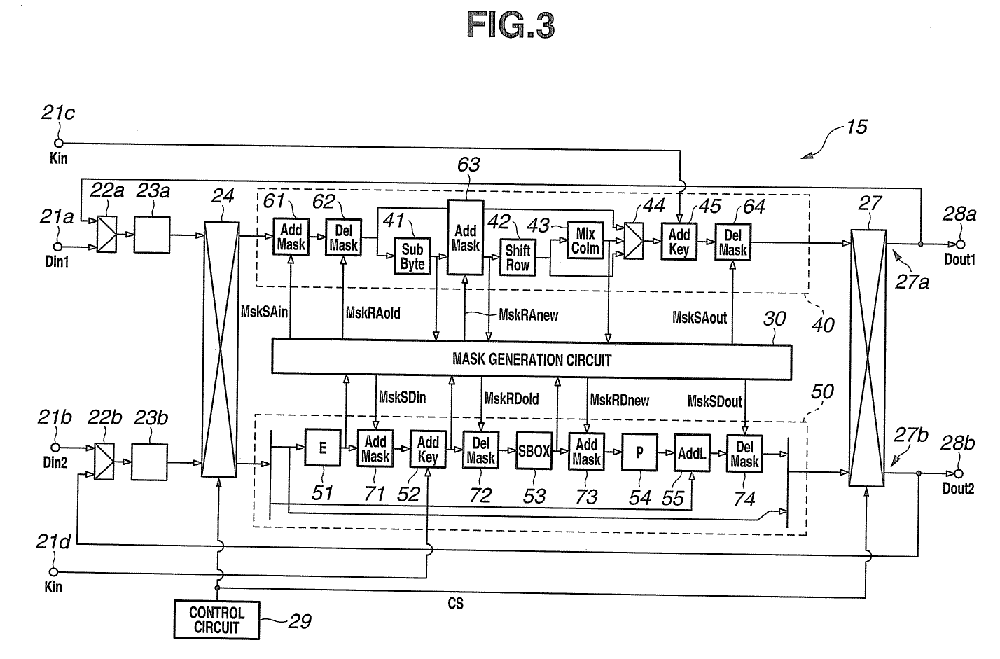

FIG. 3 is a block diagram showing the configuration of the cryptographic circuit module 15 in a case where two round function operation circuits which compute round functions in accordance with AES (Advanced Encryption Standard) and DES (Data Encryption Standard) are used. The same components as those in FIG. 2 are indicated by the same reference characters and the description thereof will not be repeated.

As shown in FIG. 3, the cryptographic circuit module 15 includes a mask generation circuit 30, a round function operation circuit 40 configured to perform a round function operation in accordance with AES, and a round function operation circuit 50 configured to perform a round function operation in accordance with DES. The cryptographic circuit module 15 also has input terminals 21c and 21d to which a round key Kin is supplied.

The round function operation circuit 40 configured to perform a round function operation in accordance with AES includes function sections: a sub-byte section (AES SubBytes) 41, a shift-row section (AES ShiftRows) 42, a mix-column section (AES MixColumns) 43, a selecting circuit 44 and an add-round key section (AddRoundKey) 45. The round function operation circuit 40 also includes an add-mask section (AddMask) 61, a delete-mask section (DelMask) 62, an add-mask section (AddMask) 63 and a delete-mask section (DelMask) 64.

The sub-byte section 41 is a nonlinear conversion table. The shift-row section 42 is a section in which replacement on a byte-by-byte basis is performed. The mix-column section 43 is a section in which multiplication on a finite body is performed. The add-round key section 45 is a section in which addition to the round key Kin, i.e., exclusive OR (XOR), is performed.

Data from the switch circuit 24 is input to the mask addition circuit, i.e., the add-mask section 61. An output from the add-mask section 61 is supplied to the delete-mask section 62. An output from the mask removal circuit, i.e., the delete-mask section 62, is supplied to the sub-byte section 41 and to the add-mask section 63. An output from the mask addition circuit, i.e., the add-mask section 63, is supplied to the shift-row section 42 and to the selecting circuit 44. An output from the shift-row section 42 is supplied to the mix-column section 43 and to the selecting circuit 44. An output from the selecting circuit 44 is supplied to the add-round key section 45. An output from the add-round key section 45 is supplied to the switch circuit 27 through the delete-mask section 64. In the case of processing in accordance with AES, different functions are used depending on rounds and, therefore, selecting from function outputs is performed by the selecting circuit 44.

Accordingly, in the round function operation circuit 40 configured to perform a round function operation in accordance with AES, the sub-byte section 41 processes data masked in the add-mask section 61 using input-side mask data MskSAin. The data processed in the sub-byte section 41 is masked data, so that the mask is deleted in the delete-mask section 64 using output-side mask data MskSAout.

Furthermore, data masked using mask data MskRAnew is transferred from the add-mask section 63 to the delete-mask section 62. That is, the add-mask section 63 masks data using the mask data MskRAnew, and transfers the masked data to the register 23a or 23b, through the shift-row section 42, the mix-column section 43, the selecting circuit 44, the add-round key section 45, the delete-mask section 64, the switch circuit 27, and the selecting circuit 22a or 22b. In the next clock, the mask data MskRAnew becomes mask data MskRAold. The data stored in the register 23a or 23b is the data masked using the mask data MskRAold, and the masked data is transferred to the delete-mask section 62 through the switch circuit 24 and the add-mask section 61. The delete-mask section 62 receives the transferred masked data and deletes the mask of the data using the mask data MskRAold.

The round function operation circuit 50 configured to perform a round function operation in accordance with DES includes an E function section 51, a key-add section (KeyAdd) 52, an SBOX section 53, an f function section 54 including a P function, and an XOR section (AddL) 55 configured to take the exclusive OR of an output from the f function section 54 and L data. The round function operation circuit 50 also includes two add-mask sections (AddMask) 71 and 73 and two delete-mask sections (DelMask) 72 and 74.

The SBOX section 53 is a nonlinear conversion table. The P function of the f function section 54 is a function for performing replacement on a bit-by-bit basis. The E function section 51 performs expansion on a bit-by-bit basis. The key-add section 52 is a section in which addition to the round key Kin (XOR) is performed.

In the round function operation circuit 50 configured to perform a round function operation in accordance with DES, the SBOX section 53 processes data masked in the add-mask section 71 using input-side mask data MskSDin. The data processed in the SBOX section 53 is masked data, so that the mask is deleted in the delete-mask section 74 using output-side mask data MskSDout.

Furthermore, data masked using mask data MskRDnew is transferred from the add-mask section 73 to the delete-mask section 72. That is, the add-mask section 73 masks data using the mask data MskRDnew and transfers the masked data to the register 23a or 23b, through the f function section 54, the XOR section (AddL) 55, the delete-mask section 74, the switch circuit 27, and the selecting circuit 22a or 22b. In the next clock, the mask data MskRDnew becomes mask data MskRDold. The data stored in the register 23a or 23b is the data masked using the mask data MskRDold, and the masked data is transferred to the delete-mask section 72 through the switch circuit 24, the E function section 51, the add-mask section 71, the key-add section 52. The delete-mask section 72 receives the transferred masked data and deletes the mask of the data using the mask data MskRDold.

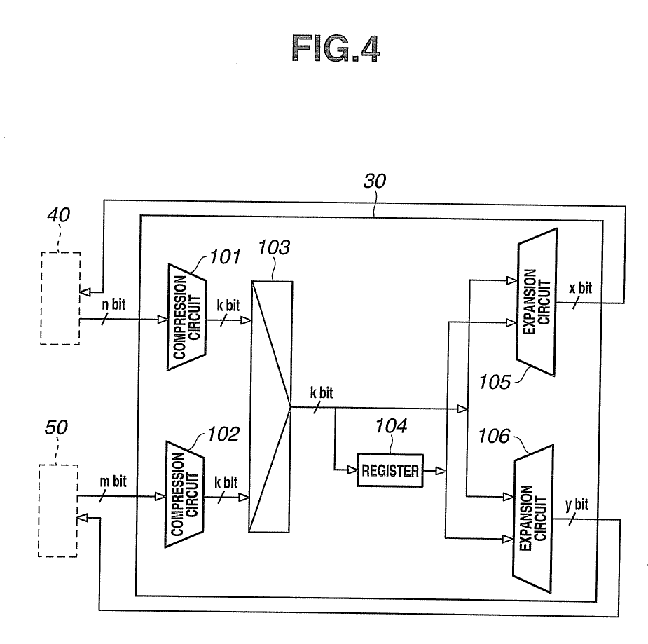

The mask generation circuit 30 will next be described. FIG. 4 is a block diagram showing the configuration of the mask generation circuit 30.

The mask generation circuit 30 is configured by including two compression circuits 101 and 102, a selecting circuit 103, a register 104 and two expansion circuits 105 and 106. The compression circuit 101 receives n-bit data from the round function operation circuit 40. The compression circuit 101 performs predetermined data compression processing on the n-bit data and supplies a k-bit output to the selecting circuit 103. The compression circuit 102 receives m-bit data from the round function operation circuit 50. The compression circuit 102 performs predetermined data compression processing on the m-bit data and supplies a k-bit output to the selecting circuit 103.

The selecting circuit 103 selects one of the two inputs and supplies k-bit data to the register 104 and the two expansion circuits 105 and 106. The expansion circuit 105 performs predetermined data expansion operation on the basis of input two groups of k-bit data, generates x-bit data and outputs the x-bit data to the round function operation circuit 40. Similarly, the expansion circuit 106 performs predetermined data expansion operation on the basis of input two groups of k-bit data, generates y-bit data and outputs the y-bit data to the round function operation circuit 50.

In the mask generation circuit 30, the compression circuit 101 compresses the n-bit intermediate data input from the round function operation circuit 40 to k bits. The compression circuit 102 compresses the m-bit intermediate data input from the round function operation circuit 50 to k bits. The output from the selecting circuit configured to select one of the outputs from the two compression circuits is held in the register 104. The expansion circuit 105 generates x-bit mask data from the output from the selecting circuit 103 and the output from the register 104, while the expansion circuit 106 generates y-bit mask data from the output from the selecting circuit 103 and the output from the register 104.

In the case of the configuration shown in FIG. 3, mask data used in the AES round function operation circuit 40 is MskSAin, MskRAold, MskRAnew and MskSAout, and mask data used in the DES round function operation circuit 50 is MskSDin, MskRDold, MskRDnew and MskSDout. Mask data MskRAold and MskRDold are mask data attached in the preceding round. The groups of mask data are removed in the next round. Mask data for removal is the mask data held in the register 104.

Examples of the compression circuits 101 and 102 include a circuit configured to select k bits from input n-bit (or m-bit) data and a circuit configured to reduce a plurality of bits by XOR for example. Examples of the expansion circuits 105 and 106 include a circuit configured to repeatedly output particular bits and a circuit configured to repeat particular bits, thereafter taking the exclusive OR (XOR) of the bits and other data and outputting the exclusive OR.

### Operation

In the above-described circuits shown in FIGS. 3 and 4, mask data used for data masking is generated by the mask generation circuit 30 from intermediate result data in AES round function operation and intermediate result data in DES round function operation.

The operation of the cryptographic circuit module 15 shown in FIG. 3 will be described. A case where the cryptographic circuit module 15 performs AES cryptographic processing will be described as an example. In this case, the DES round function operation section is used to generate mask data used in the AES round function operation section.

In AES operation, AddRoundKey processing is first performed by the add-round key section 45. Subsequently, SubBytes processing by the sub-byte section 41, ShiftRows processing by the shift-row section 42, MixColumns processing by the mix-column section 43 and AddRoundKey processing by the add-round key section 45 are repeatedly performed. Finally, SubBytes processing by the sub-byte section 41, ShiftRows processing by the shift-row section 42 and AddRoundKey processing by the add-round key section 45 are performed. Selection of processes is performed by the selecting circuit 44 selecting inputs.

In the configuration shown in FIG. 3, when AES cryptographic processing is performed, input data masked with mask data MskAR1 is first transferred from the CPU 11 to and held in the register 23a. The output from the register 23a is masked with mask data MskAS1 by the mask addition circuit, i.e., the add-mask section 61.

Next, mask data MskAR1 is removed by the mask removal circuit, i.e., the delete-mask section 62.

The data from which mask data MskAR1 has been removed is transferred to the mask addition circuit, i.e., the add-mask section 63, masked with mask data MskRA2 and transferred to the selecting circuit 44. The selecting circuit 44 first selects the output from the add-mask section 63 and transfers the output to the add-round key section 45.

In the add-round key section 45, AddRoundKey processing is performed. A result of AddRoundKey processing is transferred to the mask removal circuit, i.e., the delete-mask section 64. In the delete-mask section 64, mask data MskAS1 is removed. The data from which the mask data has been removed is transferred to the register 23 a via the switch circuit 27. AddRoundKey processing is thus performed to hold in the register 23a the operation result masked with mask data MskRA2.

Subsequently, by selecting inputs by means of the selecting circuit 44, SubBytes processing by the sub-byte section 41, ShiftRows processing by the shift-row section 42, MixColumns processing by the mix-column section 43 and AddRoundKey processing by the add-round key section 45 are repeatedly performed. Also, by selecting inputs by means of the selecting circuit 44, SubBytes processing by the sub-byte section 41, ShiftRows processing by the shift-row section 42 and AddRoundKey processing by the add-round key section 45 are finally performed.

On the other hand, data Din2 irrelevant to the AES input data is held in the register 23b for the DES round function operation circuit 50. In the round function operation circuit 50, DES round function operation processing is executed. Intermediate result data at this time is transferred to the mask generation section 30 and mask data MskSAin, MskSAout, MskRAold and MskRAnew used in AES operation are generated. Groups of mask data generated in this way are transferred to the AES round function operation circuit 40 to be used in AES round function operation processing.

The above-described example of processing is a case of processing in which cryptographic processing is performed by the AES round function operation circuit 40. In a case where cryptographic processing is performed by the DES round function operation circuit 50, each group of mask data generated in the AES round function operation circuit 40 is transferred to the DES round function operation circuit 50 to be used in DES round function operation processing.

As described above, one of the AES and DES cryptographic processing circuits is used and the output from the other cryptographic processing circuit not performing cryptographic processing is used as a mask data, thus enabling cryptographic processing to which data masking is applied to be performed without using random numbers externally supplied.

### Second Embodiment

### Configuration

A cryptographic processor according to a second embodiment of the present invention will be described. The same components as those in the first embodiment are indicated by the same reference characters and the description thereof will not be repeated.

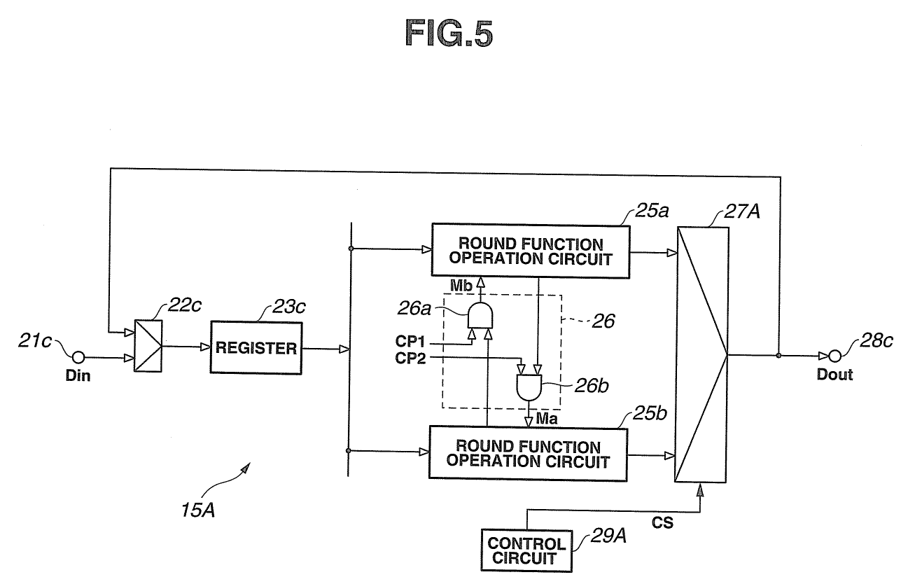

FIG. 5 is a block diagram showing the configuration of a cryptographic circuit module 15A according to the second embodiment.

As shown in FIG. 5, the cryptographic circuit module 15A is configured so as to have an input terminal 21c, a selecting circuit 22c, a register 23c, and round function operation circuits 25a and 25b configured to respectively compute predetermined round functions different from each other, a mask generation circuit 26, a selecting circuit 27A, an output terminal 28c, and a control circuit 29A. The round function operation circuits 25a and 26a are circuits configured to respectively perform cryptographic processes different from each other, i.e., encryption processes and/or decryption processes.

The present embodiment differs from the first embodiment in that one input terminal 21c, one selecting circuit 22c and one register 23c are used. The selecting circuit 27A selects the round function operation circuit performing the cryptographic operation and supplies output data from the selected round function operation circuit to the register 23c.

In many cryptographic algorithms, cryptographic processing is executed by repeatedly performing a round function operation. Also in the cryptographic circuit unit 15A shown in FIG. 5, a round function operation in a cryptographic algorithm is executed in the cryptographic operation circuit. The cryptographic circuit unit 15A shown in FIG. 5 is configured by including the input terminal 21c, i.e., an input terminal through which input data is input, the register 23c for holding a result of a round function operation, the round function operation circuits 25a and 25b configured to respectively compute round function operations different from each other, the mask generation circuit 26 configured to generate mask data from round function operation intermediate result data output from the round function operation circuits, the selecting circuit 27A for selecting result outputs from the round function operation circuits 25a and 25b, the selecting circuit 22c for selecting a round function operation result output and input data, and the output terminal 28c, which is a terminal through which an operation result is output.

### Operation

The operation of the cryptographic circuit unit 15A shown in FIG. 5 will be described. In the example of the operation described below, the round function operation circuit 25a performs cryptographic processing and the round function operation circuit 25b generates mask data.

When input data Din to be supplied to the two round function operation circuits 25a and 25b is supplied to the input terminal 21c, the data is transferred to the selecting circuit 22c. The selecting circuit 22c selects input data Din and transfers input data Din to the register 23c. The register 23c holds the transferred input data. The register 23c transfers the data held to the round function operation circuits 25a and 25b. The data input to the round function operation circuit 25a and the data input to the round function operation circuit 25b are identical to each other. The register 23c holds the identical data.

The round function operation circuit 25a capable of computing the cryptographic algorithm for a cryptographic operation on input data Din executes the round function operation using input data Din. On the other hand, the other round function operation circuit 25b also executes the round function operation using the input data and outputs an intermediate result from the operation to the mask generation circuit 26. At this time, an input CP1 to an AND circuit 26a is high and operation result data from the round function operation circuit 25b is supplied as mask data to the round function operation circuit 25a.

The intermediate result from the round function operation circuit 25b is data generated from the same input data Din but has only a weak relation with input data Din since it is a result of the operation based on an algorithm different from the cryptographic algorithm to be computed. The mask generation circuit 26 generates mask data by using the intermediate result and transfers the mask data to the round function operation circuit 25a configured to compute the cryptographic algorithm to be executed.

The round function operation circuit 25a processes the data output from the register 23c by using the mask data output from the mask generation circuit 26. A result of processing is transferred to the selecting circuit 27A. The output from the round function operation circuit 25a using the algorithm to be computed for cryptographic processing and the output from the round function operation circuit 25b are input to the selecting circuit 27A. In the selecting circuit 27A, the output from the round function operation circuit 25a using the algorithm to be computed for cryptographic processing is selected. The selected output is transferred to the selecting circuit 22c.

In the selecting circuit 22c, the operation result transferred from the selecting circuit 27A is selected to be transferred to the register 23c. The register 23c holds the output from the selecting circuit 22c. By these operations, an operation result of processing in the first round is held in the register 23c.

As described above, the same processing is repeated and the round function operation is repeated the necessary number of times to perform the cryptographic operation and to output results of the operation. In the round function operation circuit 25a, intermediate result data from the round function operation circuit 25b is used as mask data each time the round function operation is performed. With respect to a certain kind of cryptographic algorithm, processing after the round function operation is performed to produce cryptographic operation results.

In one of the round function operation circuit in the cryptographic processor according to the second embodiment described above, not random numbers externally supplied but intermediate result data produced from the other operation circuit is used as mask data for data masking, thus enabling cryptographic processing based on a data masking method to be performed without inputting any mask data from the outside of the cryptographic operation unit 15A.

In the above-described example the cryptographic operation unit 15A has two round function operation circuits. Even in a case where the cryptographic operation unit 15A has three or more round function operation circuits, however, processing can also be performed in a similar way by using one register and using intermediate result data produced in one of the round function operation circuits other than the one performing cryptographic processing. In this case, the mask generation circuit 26 is arranged to enable supply of mask data to the round function operation circuit configured to perform cryptographic processing among the three or more round function operation circuits.

Also in the present embodiment, as in the first embodiment, the above-described mask generation circuit 26 directly selects each of the outputs from the round function operation circuits 25a and 25b and outputs the selected output as mask data. However, the arrangement may alternatively be such that the mask generation circuit 26 generates mask data by performing predetermined operational processing on each of the outputs from the round function operation circuits 25a and 25b.

Further, the mask generation circuit may be a circuit configured to use compression circuits and expansion circuits such as shown in FIG. 4.

### Third Embodiment

### Configuration

A cryptographic processor according to a third embodiment of the present invention will be described. The same components as those in the first embodiment are indicated by the same reference characters and the description thereof will not be repeated. The present embodiment differs from the other embodiments in that input terminals and output terminals are provided in one-to-one relationship with corresponding cryptographic operation circuits.

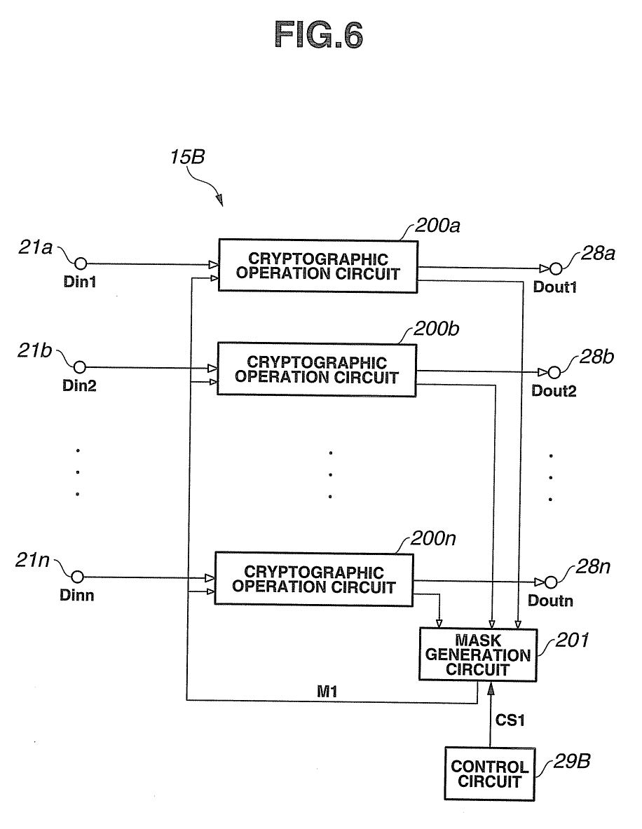

FIG. 6 is a block diagram showing the configuration of a cryptographic circuit module 15B according to the third embodiment.

As shown in FIG. 6, the cryptographic circuit module 15B is configured by including a plurality of cryptographic operation circuits 200a, 200b, . . . 200n configured to perform cryptographic processes different from each other, and a mask generation circuit 201 configured to generate mask data by using cryptographic processing results data output from the cryptographic operation circuit.

More specifically, the cryptographic circuit module 15B is configured by including a plurality of input terminals 21a, 21b, . . . 21n, the plurality of cryptographic operation circuits 200a, 200b, . . . 200n, a plurality of output terminals 28a, 28b, . . . 28n, and the mask generation circuit 201. Each cryptographic operation circuit has registers (not shown) configured to hold input data and output data.

The input terminals and output terminals are provided in correspondence with the cryptographic operation circuits. For example, the input terminal 28a is connected to the input end of the cryptographic operation circuit 200a, while the output terminal 28a is connected to the output end of the cryptographic operation circuit 200a. In other words, the number of input terminals and the number of output terminals corresponding to the number of cryptographic operation circuits are provided.

In each cryptographic operation circuit, data necessary for cryptographic processing is input from the corresponding input terminal, and cryptographic processing is performed by converting the input data into data different from the input data by using mask data generated in the mask generation circuit 201, that is, processing for encryption and/or decryption is performed, and operation results are output from the cryptographic operation circuits.

Output data from each cryptographic operation circuit is input to the mask generation circuit 201. The input data selected on the basis of a control signal CS1 from the control circuit 29B is output from the mask generation circuit 201. The control circuit 29B selects on the basis of an instruction from the CPU 11 the cryptographic operation circuit configured to output a processing result used for generation of mask data M1. The output data from the mask generation circuit 201 is supplied as mask data M1 to each cryptographic operation circuit. Thus, the mask generation circuit 201 is a circuit configured to generate mask data M1 from processing results from the cryptographic operation circuits and to supply mask data M1 to the cryptographic operation circuit configured to use mask data M1.

The mask generation circuit 201 may be a selecting circuit configured to directly output input data selected on the basis of the control signal CS1 from the control circuit 29B, or an operation circuit configured to output data obtained by performing a simple operation such as an exclusive OR operation on selected input data.

Further, the mask generation circuit 201 may be a circuit configured to use compression circuits and expansion circuits such as shown in FIG. 4.

### Operation

The operation of the cryptographic processor will be described as an example with respect to a case where predetermined cryptographic processing is performed on input data Din1 in the cryptographic operation circuit 200a. Data Din1 to be subjected to cryptographic processing is supplied to the input terminal 21a. Data Din1 is not supplied to the other input terminals 21b, . . . 21n. Data irrelevant to input data Din1, e.g., input data used in the preceding operation and results of the operation, held in an internal register, are supplied to the other input terminals. Random data or the like supplied from the CPU 11 may alternatively be supplied. In the cryptographic operation circuits 200b to 200n, cryptographic processing is performed by using such input data. Therefore, result data therefrom is data irrelevant to or having a weak relation with input data D1 to be processed in the cryptographic operation circuit 200a and available as mask data used for data masking.

The mask generation circuit 201 generates mask data M1 to be used in the cryptographic operation circuit 200a by using results data produced in the cryptographic operation circuits 200b to 200n. The mask generation circuit 201 selects and output the result data generated in one of the cryptographic operation circuits 200b to 200n on the basis of the control signal CS1 from the control circuit 29B. The data output from the mask generation circuit 201 is transferred as mask data M1 to the cryptographic operation circuit 200a.

The cryptographic operation circuit 200a performs the predetermined cryptographic processing by using input data Din1 and mask data M1 and outputs processing result data to the output terminal 28a.

A case where the cryptographic operation circuit 200a performs the cryptographic operation has been described above. Mask data is also generated and used for cryptographic processing in the same way as in cases where some of the other cryptographic operation circuits perform cryptographic processing.

Also, all or part of the cryptographic operation circuits 200a to 200n may be round function operation circuits. In such a case, data on intermediate results in operation results from the other cryptographic operation circuits may be used as mask data.

As described above, according to the present embodiment, cryptographic processing based on a data masking method can be performed without externally supplying random numbers as mask data.

As described above, the cryptographic processor in each of the embodiments described above is capable of performing cryptographic processing based on a data masking method without having random numbers externally supplied as mask data and without requiring a random number generation circuit such as that in the related art occupying a large area on a semiconductor chip.

Thus, it has been explained with the cryptographic processor in each of the above-described embodiments that a cryptographic processor and an IC card configured to perform cryptographic processing based on a data masking method without using a random number from a random number generation circuit can be provided.

Although the cryptographic processor in each embodiment has been described with respect to an example of an IC card, the cryptographic processor may be provided in any other device.

The present invention is not limited to the above-described embodiments. Various changes and modifications can be made in the embodiments without changing the gist of the present invention.

What is claimed is:

1. A cryptographic processor comprising:
a first cryptographic processing circuit configured to perform first cryptographic processing on input first data; and
a second cryptographic processing circuit configured to perform second cryptographic processing different from the first cryptographic processing on input second data by using a processing result from the first cryptographic processing circuit as mask data.

2. The cryptographic processor according to claim 1, wherein the first cryptographic processing circuit performs the first cryptographic processing on the first data by using a processing result from the second cryptographic processing circuit as mask data.

3. The cryptographic processor according to claim 2, further comprising a mask generation circuit configured to generate the mask data from the processing result from the first cryptographic processing circuit and the processing result from the second cryptographic processing circuit, and to supply the mask data to either one of the first and second cryptographic processing circuits which is configured to use the mask data.

4. The cryptographic processor according to claim 3, further comprising:
a first register configured to hold the input first data; and
a second register configured to hold the input second data, wherein the first data is irrelevant to the second data.

5. The cryptographic processor according to claim 4, further comprising a first switchover circuit configured to make a switchover between supplying data in the first register and data in the second register to the first cryptographic processing circuit and the second cryptographic processing circuit, respectively, and supplying the data in the first register and the data in the second register to the second cryptographic processing circuit and the first cryptographic processing circuit, respectively.

6. The cryptographic processor according to claim 5, further comprising a second switchover circuit configured to make a switchover between supplying the processing result from the first cryptographic processing circuit and the processing result from the second cryptographic processing circuit to the first register and the second register, respectively, and supplying the processing result from the first cryptographic processing circuit and the processing result from the second cryptographic processing circuit to the second register and the first register, respectively.

7. The cryptographic processor according to claim 3, wherein the first data and the second data are identical to each other, the cryptographic processor further comprising:
a third register configured to hold the identical data; and
a selecting circuit configured to select one of first operation result data as a result of operation in the first cryptographic processing circuit and second operation result data as a result of operation in the second cryptographic processing circuit, and to supply the selected result data to the third register.

8. The cryptographic processor according to claim 3, wherein the mask generation circuit generates the mask data by selecting one of the processing result from the first cryptographic processing circuit and the processing result from the second cryptographic processing circuit or by performing predetermined operational processing on one of the processing results.

9. The cryptographic processor according to claim 3, wherein the mask generation circuit has a circuit for data compression or data expansion and generates the mask data by performing the data compression or the data expansion on the processing result from the first cryptographic processing circuit or the processing result from the second cryptographic processing circuit.

10. The cryptographic processor according to claim 2, wherein each of the first and second cryptographic processing circuits is a round function operation circuit; the second cryptographic processing circuit uses intermediate result data from the first cryptographic processing circuit as the mask data; and the first cryptographic processing circuit uses intermediate result data from the second cryptographic processing circuit as the mask data.

11. The cryptographic processor according to claim 5, further comprising a control circuit configured to supply the first switchover circuit with a control signal designating change of the destinations to which the data in the first register and the data in the second register are supplied.

12. The cryptographic processor according to claim 6, further comprising a control circuit configured to supply the second switchover circuit with a control signal designating change of the destinations to which the processing result from the first cryptographic processing circuit and the processing result from the second cryptographic processing circuit are supplied.

13. An IC card comprising the cryptographic processor according to claim 1.

14. A cryptographic processor comprising:
a first cryptographic processing circuit configured to perform first cryptographic processing on input first data;
a second cryptographic processing circuit configured to perform second cryptographic processing different from the first cryptographic processing on input second data; and
a mask generation circuit configured to generate mask data from a processing result from the first cryptographic processing circuit and a processing result from the second cryptographic processing circuit, and to supply the mask data to either one of the first and second cryptographic processing circuits which is configured to use the mask data.

15. The cryptographic processor according to claim 14, further comprising:
a first input terminal to which the first data is supplied; and
a second input terminal to which the second data is supplied, wherein the first data is irrelevant to the second data.

16. The cryptographic processor according to claim 14, further comprising:
a first output terminal through which the processing result from the first cryptographic processing circuit is output; and
a second output terminal through which the processing result from the second cryptographic processing circuit is output.

17. The cryptographic processor according to claim 14, wherein the mask generation circuit generates the mask data by selecting one of the processing result from the first cryptographic processing circuit and the processing result from the second cryptographic processing circuit or by performing predetermined operational processing on one of the processing results.

18. The cryptographic processor according to claim 14, wherein the mask generation circuit has a circuit for data compression or data expansion and generates the mask data by performing the data compression or the data expansion on the processing result from the first cryptographic processing circuit or the processing result from the second cryptographic processing circuit.

19. The cryptographic processor according to claim 14, wherein each of the first and second cryptographic processing circuits is a round function operation circuit; the second cryptographic processing circuit uses intermediate result data from the first cryptographic processing circuit as the mask data; and the first cryptographic processing circuit uses intermediate result data from the second cryptographic processing circuit as the mask data.

20. An IC card comprising the cryptographic processor according to claim 14.
